(19) United States
(12) Patent Application Publication
(10) Pub. No.: US 2025/0315462 A1
(43) Pub. Date: Oct. 9, 2025

(54) INFORMATION PROCESSING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Xue Xiong, Beijing (CN); Xinsen Zhang, Beijing (CN); Bingxuan Li, Beijing (CN); Penghao Zhao, Beijing (CN); Guming Gao, Beijing (CN); Yongkang Xie, Beijing (CN)

(73) Assignee: BEIJING BAIDU NETCOM SCIENCE TECHNOLOGY CO., LTD., Beijing (CN)

(21) Appl. No.: 19/245,143

(22) Filed: Jun. 20, 2025

(30) Foreign Application Priority Data
Sep. 27, 2024 (CN) 202411365378.1

(51) Int. Cl. G06F 16/334; G06F 7/24; G06F 11/30; G06F 16/332

(52) U.S. Cl. CPC G06F 16/334; G06F 7/24; G06F 11/3051; G06F 16/3326

(57) ABSTRACT

An information processing method, an electronic device, and a storage medium. The method includes: obtaining a query statement of a user, determining at least one model identifier of at least one candidate service model based on the query statement; generating at least one first prompt word based on the query statement and the at least one model identifier, inputting the at least one first prompt word into a pre-trained target large model, and outputting, by the target large model, at least one screening parameter of the at least one candidate service model based on the at least one first prompt word; determining a target service model from the at least one candidate service model based on the at least one screening parameter; and inputting the query statement into the target service model, and obtaining feedback information corresponding to the query statement.

### CROSS REFERENCE TO RELATED APPLICATION

This application is based on and claims priority to Chinese patent application No. 2024113653781, filed on Sep. 27, 2024, the entire content of which is hereby introduced into this application as a reference.

### TECHNICAL FIELD

The present disclosure relates to the field of artificial intelligence technologies, specifically to the field of large model, and deep learning technologies, and particularly to an information processing method, an electronic device, and a storage medium.

### BACKGROUND

In related art, a most suitable expert model is selected for input data depending on a dynamic selection mechanism based on a mixture of experts (MoE) architecture. For example, the most suitable expert model is selected for the input data through a gating network, or the most suitable expert model is selected for the input data through a weight allocation strategy. However, the above method cannot accurately and efficiently select the most suitable expert model for the input data.

### SUMMARY

According to a first aspect of the present disclosure, an information processing method is provided, including: obtaining a query statement of a user, determining at least one model identifier of at least one candidate service model based on the query statement; generating at least one first prompt word based on the query statement and the at least one model identifier, inputting the at least one first prompt word into a pre-trained target large model, and outputting, by the target large model, at least one screening parameter of the at least one candidate service model based on the at least one first prompt word; determining a target service model from the at least one candidate service model based on the at least one screening parameter; and inputting the query statement into the target service model, and obtaining feedback information corresponding to the query statement.

According to a second aspect of the present disclosure, an electronic device is provided, including: a processor and a memory, in which the memory stores instructions executable by the processor, the processor is configured to obtain a query statement of a user, determine at least one model identifier of at least one candidate service model based on the query statement; generate at least one first prompt word based on the query statement and the at least one model identifier, input the at least one first prompt word into a pre-trained target large model, and output, by the target large model, at least one screening parameter of the at least one candidate service model based on the at least one first prompt word; determine a target service model from the at least one candidate service model based on the at least one screening parameter; and input the query statement into the target service model, and obtain feedback information corresponding to the query statement.

According to a third aspect of the present disclosure, a non-transiency computer-readable storage medium storing computer instructions is provided. The storage medium stores computer instructions which cause a computer to implement the information processing method. The method includes: obtaining a query statement of a user, determining at least one model identifier of at least one candidate service model based on the query statement; generating at least one first prompt word based on the query statement and the at least one model identifier, inputting the at least one first prompt word into a pre-trained target large model, and outputting, by the target large model, at least one screening parameter of the at least one candidate service model based on the at least one first prompt word; determining a target service model from the at least one candidate service model based on the at least one screening parameter; and inputting the query statement into the target service model, and obtaining feedback information corresponding to the query statement.

It should be understood that what is described in this section is not intended to identify key or important features of embodiments of the present disclosure, and is also not intended to limit the scope of the disclosure. Other features of the disclosure will be readily understood by the following specification.

### BRIEF DESCRIPTION OF THE DRAWINGS

The accompanying drawings are used for a better understanding of the disclosure and do not constitute a limitation of the disclosure.

FIG. 1 is a flowchart of an information processing method according to an embodiment of the present disclosure.

FIG. 2 is a flowchart of an information processing method according to an embodiment of the present disclosure.

FIG. 3 is a flowchart of a method for training a target large module according to an embodiment of the present disclosure.

FIG. 4 is a flowchart of a method for training a target large module according to an embodiment of the present disclosure.

FIG. 5 is a flowchart of an information processing method according to an embodiment of the present disclosure.

FIG. 6 is a block diagram of an information processing apparatus according to an embodiment of the present disclosure.

FIG. 7 is a block diagram of an electronic device according to an embodiment of the present disclosure.

### DETAILED DESCRIPTION

Exemplary embodiments of the present disclosure are described hereinafter in conjunction with the accompanying drawings, which include various details of the embodiments of the present disclosure in order to aid in understanding, and should be considered exemplary only. Accordingly, one of ordinary skill in the art should recognize that various changes and modifications may be made to the embodiments described herein without departing from the scope and spirit of the disclosure. Similarly, descriptions of well-known features and structures are omitted from the following description for the sake of clarity and brevity.

Artificial Intelligence (AI) is a technical science that studies and develops theories, methods, techniques and application systems for simulating, extending and expanding human intelligence.

Large model is a machine learning model with a huge parameter scale and complexity, which requires a lot of computing resources and storage space to train and store, and often requires distributed computing and special hardware acceleration technologies. The large model has stronger generalization and expression ability.

Deep learning (DL) is a new research direction in the field of machine learning (ML), which has been introduced into machine learning to bring it closer to its original target-artificial intelligence. The deep learning is a science that learns internal rules and representation levels of sample data. Information obtained during these learning processes is of great help in interpreting data such as texts, images, and sounds. An ultimate target of the deep learning is to cause a machine to have an ability to analyze and learn like humans and to recognize data such as the texts, the images, and the sounds.

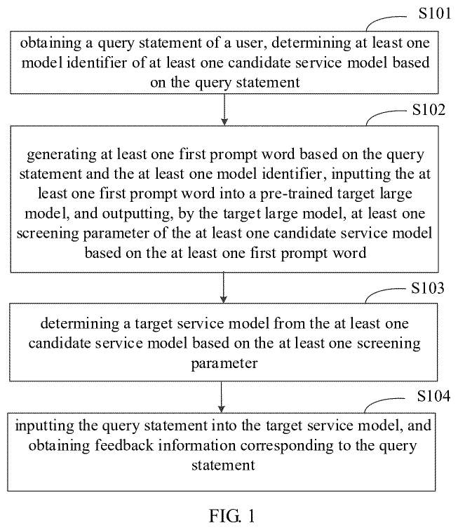

FIG. 1 is a flowchart of an information processing method according to an embodiment of the present disclosure. As shown in FIG. 1, the method includes the following blocks.

At block S101, a query statement of a user is obtained, and at least one model identifier of at least one candidate service model is determined based on the query statement.

It is noted that a subject matter for executing the method in embodiments of the present disclosure may be a hardware device with a data information processing capability and/or software necessary to drive work of the hardware device. For example, the subject matter may include a workstation, a server, a computer, a user terminal, and other intelligent devices. The user terminal includes but is not limited to a mobile phone, a computer, an intelligent voice interaction device, a smart home appliance, an in-vehicle/vehicle-mounted terminal, etc.

In an embodiment of the present disclosure, the query statement of the user sent by a client may be received through a software development kit (SDK) component, to obtain the query statement of the user.

It is noted that in order to ensure that the user can seamlessly integrate services of a system (information processing system), after obtaining the query statement of the user, the query statement of the user may be standardized to obtain a standard query statement.

In an example, the query statement is parsed through the SDK component, key information is obtained from the query statement, and a standard query statement is generated based on the key information. The key information at least includes the at least one model identifier of the at least one candidate service model and context information of the candidate service model.

The identifier of the candidate service model includes, but is not limited to, a name of the candidate service model, an identity document (ID) of the candidate service model.

In an example, when the user selects a service model from a service model list of the client, a selected service model is taken as the candidate service model. When the user selects no service model from the service model list of the client, a default service model is taken as the candidate service model.

For example, for a service model list of {Model A, Model B, Model C, Model D, Model E}, in a case where service models selected by the user are {Model A, Model C, Model D}, the service models of {Model A, Model C, Model D} may be taken as the candidate service models, while in a case where the user selects no service model, then the default service models of {Model A, Model B, Model C, Model D} may be taken as the candidate service models.

The context information may be single round dialogue information or multi-round dialogue information. In a case where the context information is multi-round dialogue information, the last round of dialogue information is the context information of the query statement, and dialogue information of other rounds is historical dialogue information. A length threshold of the context information may be preset according to an actual situation.

In an embodiment of the present disclosure, after obtaining the standard query statement, a communication protocol of the standard query statement may be converted and user identity information corresponding to the standard query statement may be authenticated and verified.

In an example, the standard query statement may be forwarded to internal services of the system through an open application programming interface (API) component, and the communication protocol of the standard query statement may be converted, and the user identity information corresponding to the standard query statements can be authenticated and verified.

In an example, in a case where authentication and verification of the user identity information corresponding to the standard query statement are both successful, the model identifier of the candidate service model may determined from parsed information by parsing the query statement.

In an example, training samples may be input into KANs, which perform task training on text data to obtain an output result of the KANs. A loss value of the KANs may be determined based on the output result of KANs, and the model parameters of the KANs may be adjusted based on the loss value, and then it is returned to the next training sample to continue training the KANs after adjusting the model parameters, until a model training end condition is met, resulting in a first pre-trained large language model.

At block S102, at least one first prompt word is generated based on the query statement and the at least one model identifier, the at least one first prompt word is input into a pre-trained target large model, and the target large model outputs at least one screening parameter of the at least one candidate service model based on the at least one first prompt word.

In an embodiment of the present disclosure, after obtaining the query statement and the at least one model identifier, the query statement may be combined with each model identifier to generate the first prompt word.

For example, in a case where the query statement is “Please imitate Lu Xun's style to generate a comment” and the model identifiers are {Model A, Model C, Model D}, then a first prompt word prompt1 is “Please imitate Lu Xun's style to generate a comment+Model A”, a first prompt word prompt2 is “Please imitate Lu Xun's style to generate a comment+Model C”, and a first prompt word prompt3 is “Please imitate Lu Xun's style to generate a comment+Model D”.

In an embodiment of the present disclosure, after obtaining the first prompt word, the first prompt word may be input into the pre-trained target large model, and the target large model may output the screening parameter of the candidate service model based on the first prompt word.

In an example, model usage history data of a user associated with the query statement may be obtained. A training sample set and a sample service model of a large model are determined according to the model usage history data, the training sample set includes sample query statements of the large model. Reference labels of the sample query statements are determined based on the sample service model. The large model is trained based on the sample query statements, a model identifier of the sample service model, and reference labels of the sample query statements, and the target large model is obtained.

The screening parameter of the candidate service model may be a score of the candidate service model.

For example, the first prompt word prompt1 “Please imitate Lu Xun's style to generate a comment+model A” is input into the target large model, and the target large model outputs a score Score_{A} of the model A. The first prompt word prompt2 “Please imitate Lu Xun's style to generate a comment+model C” is input into the target large model, and the target large model outputs a score Score_{C} of the model C. The first prompt word prompt3 “Please imitate Lu Xun's style to generate a comment+model D” is input into the target large model, and the target large model outputs a score Score_{D} of the model D.

At block S103, a target service model is determined from the at least one candidate service model based on the at least one screening parameter.

In an embodiment of the present disclosure, after obtaining the screening parameter, the target service model may be determined from the candidate service model based on the screening parameter.

It is noted that a specific method of determining the target service model from the at least one candidate service model based on the at least one screening parameter is not limited in the disclosure, and may be selected according to actual situations.

In an example, the at least one candidate service model is sorted in descending order according to the at least one screening parameter, and a first candidate service model ranked first is selected, and the first candidate service model ranked first is taken as the target service model.

For example, in a case where the score Score_{A} of the model A, the score Score_{C} of the model C, and the score Score_{D} of the model D are sorted in descending order, and the sorting result is Score_{A}>Score_{D}>Score_{C}, the model A may be selected as the target service model.

At block S104, the query statement is inputted into the target service model, and feedback information corresponding to the query statement is obtained.

In an embodiment of the present disclosure, after obtaining the target service model, the query statement may be input to the target service model to obtain the feedback information corresponding to the query statement.

For example, in a case where the target service model is the model A and the query statement is “Please imitate Lu Xun's style to generate a comment”, the statement “Please imitate Lu Xun's style to generate a comment” is inputted into the model A to obtain the feedback information corresponding to the query statement.

According to the information processing method provided in the present disclosure, the query statement of the user is obtained, and the at least one model identifier of the at least one candidate service model is determined based on the query statement. The at least one first prompt word is generated based on the query statement and the at least one model identifier, the at least one first prompt word is input into the pre-trained target large model, and the target large model outputs the at least one screening parameter of the at least one candidate service model based on the at least one first prompt word. The target service model is determined from the at least one candidate service model based on the at least one screening parameter. The query statement is inputted into the target service model, and the feedback information corresponding to the query statement is obtained. Therefore, in the present disclosure, with determining the target service model based on the at least one screening parameter of the at least one candidate service model output by the target large model, an efficiency, an accuracy, and flexibility of determining the target service model may be improved, and with inputting the query statement into the target service model to obtain the feedback information corresponding to the query statement, a computing capability of the target service model may be utilized to the most extent, and an efficiency and an accuracy of outputting the feedback information of the target service model may be ensured.

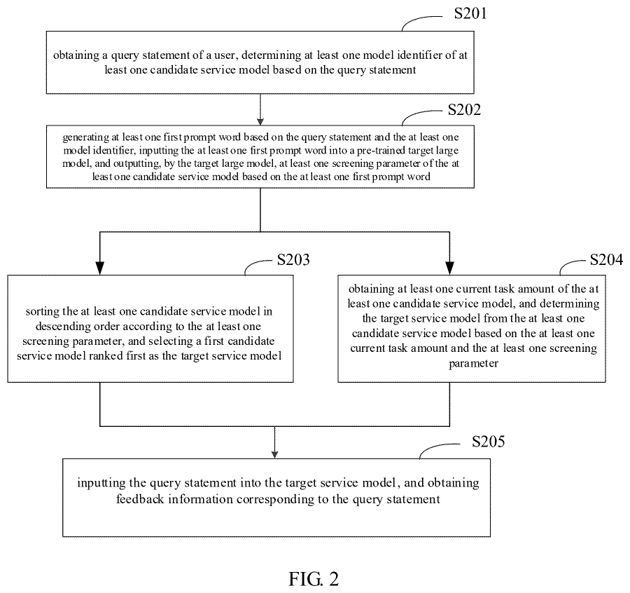

FIG. 2 is a flowchart of an information processing method according to an embodiment of the present disclosure.

As shown in FIG. 2, on the basic of the embodiment as shown in FIG. 2, the information processing method according to the embodiment of the present disclosure may include the following blocks.

At block S201, a query statement of a user is obtained, and at least one model identifier of at least one candidate service model is determined based on the query statement.

At block S202, at least one first prompt word is generated based on the query statement and the at least one model identifier, the at least one first prompt word is input into a pre-trained target large model, and the target large model outputs at least one screening parameter of the at least one candidate service model based on the at least one first prompt word.

Relevant contents of blocks S201 and S202 may be found in the above embodiments, and will not be repeated herein.

In an embodiment, the block S103 “determining a target service model from the at least one candidate service model based on the at least one screening parameter” in the above embodiment may specifically include block S203.

At block S203, the at least one candidate service model is sorted in descending order according to the at least one screening parameter, and a first candidate service model ranked first is selected as the target service model.

For example, for a candidate service model A, a candidate service model C, and a candidate service model D, the candidate service model A has a score of Score_{A}, the candidate service model C has a score of Score_{C}, and the candidate service model D has a score of Score_{D}. The score Score_{A}, the score Score_{C}, and the score Score_{D} are sorted in descending order, and the sorting result is Score_{A}>Score_{D}>Score_{C}. Therefore, the candidate service model A is selected as the target service model.

In an embodiment, the block S103 “determining the target service model from the at least one candidate service model based on the at least one screening parameter” in the above embodiment may specifically include block S204.

At block S204, at least one current task amount of the at least one candidate service model is obtained, and the target service model is determined from the at least one candidate service model based on the at least one current task amount and the at least one screening parameter.

It is noted that in order to ensure reasonable allocation of resources, achieve resource balance, and ensure system stability, the current task amount of the candidate service model may be obtained, and the target service model may be determined from the at least one candidate service model based on the at least one task amount and the at least one screening parameter.

It is noted that a specific method of determining the target service model from the at least one candidate service model based on the at least one current task amount and the at least one screening parameter is not limited in the present disclosure, and may be selected according to actual situations.

In an example, the at least one candidate service model is sorted in descending order according to the at least one screening parameter, and a first candidate service model ranked first is determined. A second candidate service model ranked second is determined as the target service model in response to the current task amount of the first candidate service model being greater than a predetermined threshold.

For example, for the candidate service model A, the candidate service model C, and the candidate service model D, the candidate service model A has the score of Score_{A}, the candidate service model C has the score of Score_{C}, and the candidate service model D has the score of Score_{D}, the score Score_{A}, the score Score_{C}, and the score Score_{D} are sorted in descending order, and the sorting result is Score_{A}>Score_{D}>Score_{C}, then the candidate service model A is taken as the first service model. In response to the task amount M_{A} of the candidate service model A being greater than a predetermined value M_{S}, the candidate service model Score_{D} ranked second is determined as the target service model.

In an example, the at least one candidate service model is sorted in descending order according to the at least one screening parameter to obtain a first sorting result. At least one current task amount of the at least one candidate service model is obtained, and the first sorting result is adjusted based on the at least one current task amount to obtain the second sorting result. A third candidate service model sorted first in the second sorting result is selected as the target service model.

For example, for the candidate service model A, the candidate service model C, and the candidate service model D, the candidate service model A has the score of Score_{A}, the candidate service model C has the score of Score_{C}, and the candidate service model D has the score of Score_{D}, the score Score_{A}, the score Score_{C}, and the score Score_{D} are sorted in descending order, and the first sorting result is Score_{A}>Score_{D}>Score_{C}, the current task amount of the candidate service model A is M_{A}, the current task amount of the candidate service model C is M_{C}, the current task amount of the candidate service model D is M_{D}, then in response to the current task amount M_{C} of the candidate service model C being greater than the predetermined threshold value M_{S}, the second sorting result is Score_{D}>Score_{A}>Score_{C}, the third candidate service model Score_{D} sorted first is selected as the target service model.

At block S205, the query statement is inputted into the target service model, and feedback information corresponding to the query statement is obtained.

In an embodiment of the present disclosure, after obtaining the feedback information corresponding to the query statement, the amount of resources used by the target service model may be monitored during a process of processing the query statement, and billing information corresponding to the query statement is generated based on the amount of resources used by the target service model.

According to the information processing method provided in the present disclosure, the query statement of the user is obtained, and the at least one model identifier of the at least one candidate service model is determined based on the query statement. The at least one first prompt word is generated based on the query statement and the at least one model identifier, the at least one first prompt word is input into the pre-trained target large model, and the target large model outputs the at least one screening parameter of the at least one candidate service model based on the at least one first prompt word. The at least one candidate service model is sorted in descending order according to the at least one screening parameter, and the first candidate service model ranked first is selected as the target service model. The at least one current task amount of the at least one candidate service model is obtained, and the target service model is determined from the at least one candidate service model based on the at least one current task amount and the at least one screening parameter. The query statement is inputted into the target service model, and the feedback information corresponding to the query statement is obtained. The amount of resources used by the target service model may be monitored during a process of processing the query statement, and the billing information corresponding to the query statement is generated based on the amount of resources used by the target service model. Therefore, in the disclosure, with determining the target service model based on the screening parameter of the candidate service model output by the target large model, a model selection problem currently existing in the MoE model system may be solved, the target service model may be selected more quickly, accurately, and flexibly, a response delay of the target service model may be shorten. With inputting the query statement into the target service model, and obtaining the feedback information corresponding to the query statement, an inference efficiency of the target service model may be greatly improved, and a computing capability of each target service model may be utilized to the most extent, and a resource utilization rate of each service model may be improved.

The process of training the target large model provided in the disclosure may be explained below.

FIG. 3 is a flowchart of a method for training a target large module according to an embodiment of the present disclosure.

As shown in FIG. 3, on the basic of the embodiment as shown in FIG. 3, the process of training the target large model in an embodiment of the present disclosure may specifically include the following blocks.

At block S301, model usage history data of a user associated with the query statement is obtained.

At block S302, a training sample set and a sample service model of a large model are determined according to the model usage history data. The training sample set includes sample query statements of the large model.

In an embodiment of the present disclosure, candidate query statements are obtained according to the model usage history data, and target categories of the candidate query statements are obtained. The candidate query statements are grouped according to the target categories to obtain a query statement set corresponding to each of the target categories. Part of candidate query statements are selected from the query statement set corresponding to each category as sample query statements. The training sample set is obtained based on the sample query statements selected from each category.

It is noted that in the disclosure, in order to improve balance of the sample query statements, part of candidate query statements may be selected from the query statement set corresponding to each category, for example, 10000 candidate query statements are selected from the query statement set corresponding to each category, and the 10000 candidate query statements selected are taken as the sample query statements.

In an example, the candidate query statements may be matched with category description information of subcategories of preset second prompt words, and target subcategories matched with the candidate query statements may be obtained. The target subcategories are mapped to a plurality of predetermined candidate categories, and candidate categories to which the target subcategories are mapped are taken as the target categories of the candidate query statements.

In an example, the candidate query statements may be input into a pre-trained classification model to match the candidate query statements with the category description information of the subcategories of the preset second prompt words, and the target subcategories matched with the candidate query statements may be obtained.

For example, the category description information of the subcategories of the second prompt words may include “controversial moral issues related to pornography, online fraud, phishing emails, legal safety and other dangers”, “demand on writing codes, or explaining and changing codes”, “answer a question based on a table, etc.”, “daily greetings or answer a user question (a game, encyclopedia, product repair) using knowledge acquired during training, meaningless content, and opinions and suggestions on a problem”, “subject choice questions with clearly defined optional options”, “text translation”, “mathematical problems or logical reasoning problems”, “classification tasks, novel classification, field classification, tag selection, text classification, document classification, emotion classification, and selecting appropriate action tags”, “create a test paper, write an outline, an advertising copy, a composition, an article, an idiom and an ancient poem, a resume, a press release, a legal document, an email, or brainstorming”, “determination of intention based on historical conversations and user questions, an intention classification task, a state converter, selection of intent from a candidate set, reflection on task execution, selection of called functions, or selection of the next action”, “provide a relevant document, a user guide, a search result, and answer a user question based on text information extracted by summarizing and generalizing”, “provide a relevant document and extract an entity, an address, a name, and other information from the document and extract a specific content”, “generate a title, summarize contents of text, image, and video, and summarize a given dialogue”, “rewrite a historical dialogue to generate a new question, generate a new question based on search records, provide a search suggestion, a refine question, a construct query”, “rewrite a question or a query”, “rewrite and correct a text or a sentence”, “provide a new question based on content, generate a question, and generating a question-answer sample pair”, “chat in a specific role”, “generate simulated dialogue data according to requirements (roles, tasks)”, “continue writing, keep writing, and continue to supplement”, “summary, abbreviation, abstract, and title creation”, “content optimization, modify a document as required, change a title or a nickname, and regenerate a different content, etc.”, “health question-answer, psychological counseling, life advice, medical consultation, legal consultation”, “keyword extraction, generate a keyword for a given document”, “product value issues, comparison between competitors and evaluation of other competitors”, “copywriting creation includes (social media influencer, e-commerce, Livestream selling, WeChat mini program)”, “question that should be refused to answer which may not meet a requirement of a role or may violate laws and regulations”, “generate image or video data as required or based on a given scenario”, “scenery spot introduction, scenery spot description, a guide itinerary”, “quality rating, output scoring”, “provide a search result, a table, a text and other data”, “decompose a question or a query”, “acted as intelligent customer service to answer a user question”, and “write an answer or an article based on a specified theme, reference information, etc.”.

In an example, the disclosure may pre-set a plurality of candidate categories based on traffic attributes, for example, pre-set 15 candidate categories.

For example, the plurality of candidate categories may include “code interpreter”, “close-book answer”, “information extraction”, “creation and continuation”, “intention recognition”, “abstract”, “rewriting and correction”, “label and classification”, “legal, ethical, safety, and product value considerations”, “structured data question and answer”, “translation”, “role dialogue”, “question rewriting and sample generation”, “reading comprehension”, “mathematics and logic”.

In an embodiment of the present disclosure, candidate sample service models may be obtained according to the model usage history data, and usage frequencies of the candidate sample service models may be determined, and a candidate sample service model with a usage frequency greater than a predetermined value is selected as the sample service model.

At block S303, reference labels of the sample query statements are determined based on the sample service model.

In an embodiment of the present disclosure, answer information of the sample query statements is obtained based on the sample service model, standard answer information for the sample query statements is obtained, and the reference labels of the sample query statements are determined based on the answer information and the standard answer information.

In an example, the sample query statements may be inputted into the sample service model to obtain the answer information corresponding to the sample query statements.

In an example, the sample query statements may be inputted into a pre-trained high-order service model to obtain the standard answer information corresponding to the sample query statements.

It is noted that a specific method of determining the reference labels of the sample query statements based on the answer information and the standard answer information is not limited in the disclosure, and may be selected according to actual situations.

Optionally, it may be determined whether the answer information is consistent with the standard answer information. In a case where the answer information is consistent with the standard answer information, the reference label of the sample query statement is set as 1. In a case where the answer information is inconsistent with the standard answer information, the reference label of the sample query statement is set as 0.

In an example, a Rouge score between the answer information and the standard answer information may be obtained. In a case where the Rouge score is greater than or equal to a predetermined score threshold, the reference label of the sample query statement is set as 1. In a case where the Rouge score is less than the predetermined score threshold, the reference label of the sample query statement is set as 0.

It is noted that the answer information may be scored using a pre-trained high-order large model, and the score of the answer information may be normalized to a value within a range of [0, 1] according to a preset normalization rule.

At block S304, the large model is trained based on the sample query statements, a model identifier of the sample service model, and reference labels of the sample query statements, and the target large model is obtained.

In an example, the large model may be a bidirectional encoder representations from transformers (BERT) model.

In an embodiment of the present disclosure, a third prompt word may be generated based on the sample query statements and the model identifier of the sample service model. The third prompt word is inputted into the large model, and predicted labels of the sample query statements is obtained based on the third prompt word by the large model. A loss function of the large model is determined based on the predicted labels and the reference labels, and model parameters of the large model are adjusted based on the loss function until training is completed to obtain the target large model.

In an example, the third prompt word may be input into the large model, and the large model may perform task training on the third prompt word to obtain an output result of the large model. A loss value of the large model may be determined based on the output result of the large model, and the model parameters of the large model may be adjusted based on the loss value. It is be returned to adopt the next third prompt word to continue training the large module with the model parameters being adjusted, until a model training end condition is met, and the target large model that training is completed is obtained.

It is noted that settings of the model training end condition is not limited in the disclosure, and may be set according to actual situations.

In an example, the model training end condition may be set as a target loss value being less than a predetermined loss threshold. In an example, the model training end condition may be set as the number of adjustments to the model parameters of a second large language model reaching a predetermined threshold.

In an embodiment of the present disclosure, after obtaining the pre-trained target large model, a prompt word may be generated based on the query statement of the user and the model identifier of the candidate service model, and the prompt word may be input into the pre-trained target large model. The target large model outputs the screening parameter of the candidate service model based on the prompt word.

The following is an explanation of a specific process of the method for training the target large model proposed in the disclosure.

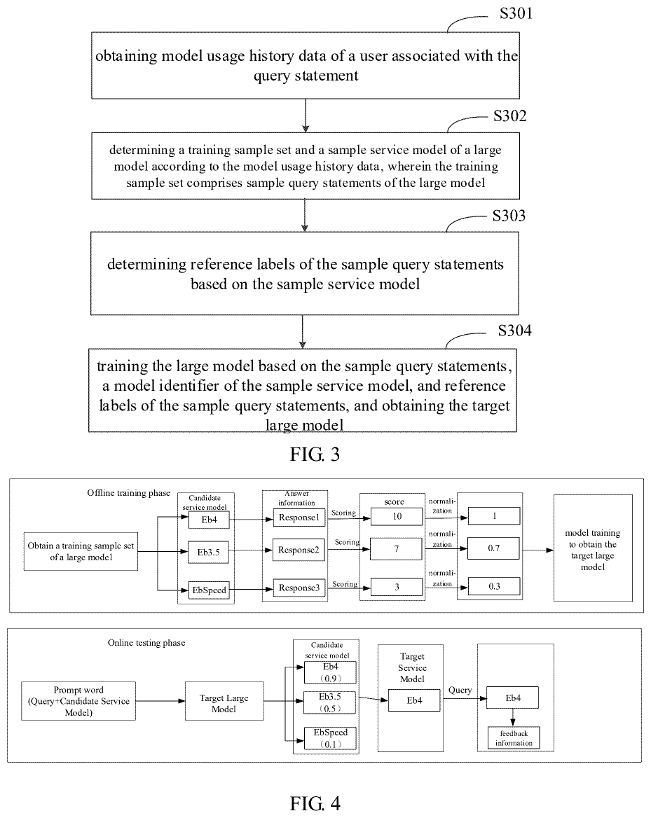

For example, as shown in FIG. 4, for an offline training phase (train offline), the process may include: (1) obtaining a training sample set (Train Querys) of a large model, which includes: grouping candidate query statements according to target categories of the candidate query statements, obtaining a query statement set corresponding to each category, selecting part of candidate query statements (balanced sampling) from the query statement set corresponding to each category as the sample query statements, and obtaining the training sample set based on the selected sample query statements in each category; (2) obtaining sample service models: for example, the sample service models may be Eb4, Eb3.5, EbSpeed; (3) obtaining answer information of the sample query statements, for example, obtaining answer information Response1 of the sample query statement based on a sample service model Eb4, obtaining answer information Response2 of the sample query statement based on a sample service model Eb3.5, and obtaining answer information Response3 of the sample query statement based on a sample service model EbSpeed; (4) by means of a pre-trained high-order large model, scoring the answer information Response1, the answer information Response2, and the answer information Response3, respectively, and determining a score of Response1 as 10, a score of Response2 as 7, and a score of Response3 as 1; (5) performing normalization, to normalize the scores to a range of [0,1]; (6) performing model training, generating a prompt word based on sample query statements and a model identifier of a sample service model, inputting the third prompt word into the large model BERT, and obtaining, by the large model, predicted labels of the sample query statements according to the prompt word, determining a loss function of the large model based on the predicted labels and reference labels, and adjusting model parameters of the large module based on the loss function until the training is completed to obtain the target large model. For an online testing phase (Test Online), a prompt word is generated based on the query statement and the model identifiers of the candidate service models (Eb4, Eb3.5, and EbSpeed). A first prompt word is input into a pre-trained target large model, and the target large model outputs, based on the first prompt word, a score (screening parameter) 0.9 of the candidate service model Eb4 based on the first prompt word, a score 0.5 of the candidate service model Eb3.5, and a score 0.1 of the candidate service model EbSpeed. The candidate service model Eb4 may be taken as the target service model, and the query statement may be input to the target service model Eb4 to obtain feedback information corresponding to the query statement.

According to the information processing method in the present disclosure, the model usage history data of the user associated with the query statement is obtained. The training sample set and the sample service model of the large model are determined according to the model usage history data. The training sample set includes the sample query statements of the large model. The reference labels of the sample query statements are determined based on the sample service model. The large model is trained based on the sample query statements, the model identifier of the sample service model, and the reference labels of the sample query statements, and the target large model is obtained. Therefore, the disclosure improves accuracy and reliability of the process of training the large model, laying a foundation for faster, more accurately, and flexibly outputting the screening parameters of the candidate service models based on the target large model, and determining the target service model.

The following is an explanation of a specific process of the information processing method proposed in the disclosure.

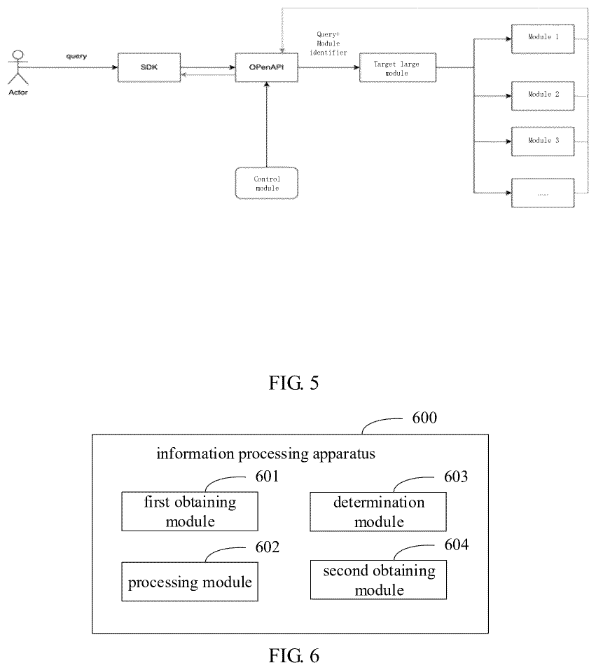

For example, as shown in FIG. 5, an information processing system may be constructed according to the information processing method provided in the disclosure, which includes a SDK module, an Open API module, a MoE module, and a control module.

For the SDK module, the SDK module may receive a query statement sent by a client, parse the query statement, obtain key information in the query statement, and generate a standard query statement based on the key information, where the key information at least includes a model identifier of a candidate service model and context information. For the Open API module, the Open API module may convert a communication protocol of the standard query statement, and authenticate and verify user identity information corresponding to the standard query statement. For the MoE module, a prompt word generated based on the query statement and the model identifier may be input into a pre-trained target large model. The target large model outputs screening parameters of candidate service models (Model 1, Model 2, Model 3 . . . ) based on the prompt word, and an optimal service model, namely a target service model, may be determined from the Model 1, Model 2, Model 3 . . . , based on the screening parameters. The target service model is used to process the query statement, and after determining the target service model, the target service model returns to the Open API module and then returns to the SDK module through the Open API module. For the control module, the control module may monitor the amount of resources used by the target service model during a process of processing the query statement, and generate billing information corresponding to the query statement based on the amount of resources used by the target service model. This may ensure reasonable allocation of system resources, record usage of service models, perform user billing, and regulate traffic when necessary to ensure system stability.

Application scenarios of the information processing method proposed in the disclosure may include but are not limited to: optimization of an inference service in a large-scale machine learning platform, selection of an expert model in a natural language processing task, and a complex system for real-time decision-making and intelligent routing.

In summary, according to the information processing method proposed in the disclosure, by means of introducing a routing strategy in peripheral service calls, a routing bottleneck in a traditional MoE model is bypassed, the query statement is routed to a most suitable expert model, thus significantly improving a processing efficiency of the query statement. The disclosure may flexibly, quickly, and accurately select the most suitable expert model based on different query statements, achieve higher resource utilization and lower response time, and fully utilize computing capabilities of all expert models, reduce usage amount of computing resources, improve an overall performance of the system, and reduce final usage costs of a user. The method of the disclosure may be applied to any application scenario that requires efficient expert model selection and deployment.

In the technical solution of the present disclosure, processing including collection, storage, use, processing, transmission, provision and disclosure of the user's personal information is in compliance with the provisions of relevant laws and regulations, and do not violate public order and moral.

According to the embodiments of the present disclosure, an information processing apparatus is also provided, configured to realize the above method.

FIG. 6 is a block diagram of an information processing apparatus according to an embodiment of the present disclosure.

As shown in FIG. 6, the apparatus 600 includes: a first obtaining module 601, a processing module 602, a determination module 603 and a second obtaining module 604.

The first obtaining module 901 is configured to obtain a query statement of a user, determining at least one model identifier of at least one candidate service model based on the query statement.

The processing module 602 is configured to generate at least one first prompt word based on the query statement and the at least one model identifier, input the at least one first prompt word into a pre-trained target large model, and output, by the target large model, at least one screening parameter of the at least one candidate service model based on the at least one first prompt word.

The determination module 603 is configured to determine a target service model from the at least one candidate service model based on the at least one screening parameter; and

The second obtaining module 604 is configured to input the query statement into the target service model, and obtain feedback information corresponding to the query statement.

In an embodiment of the present disclosure, the determination module 603 is configured to sort the at least one candidate service model in descending order according to the at least one screening parameter, and select a first candidate service model ranked first as the target service model.

In an embodiment of the present disclosure, the determination module 603 is configured to obtain at least one current task amount of the at least one candidate service model, and determine the target service model from the at least one candidate service model based on the at least one current task amount and the at least one screening parameter.

In an embodiment of the present disclosure, the determination module 603 is configured to sort the at least one candidate service model in descending order according to the at least one screening parameter, and selecting a first candidate service model ranked first; and determine a second candidate service model ranked second as the target service model in response to the current task amount of the first candidate service model being greater than a predetermined threshold.

In an embodiment of the present disclosure, the determination module 603 is configured to sort the at least one candidate service model in descending order according to the at least one screening parameter to obtain a first sorting result; obtain at least one current task amount of the at least one candidate service model, and adjusting the first sorting result based on the at least one current task amount to obtain a second sorting result; and select a third candidate service model sorted first in the second sorting result as the target service model.

In an embodiment of the present disclosure, after obtain the feedback information corresponding to the query statement, the apparatus 600 is configured to monitor the amount of resources used by the target service model during a process of processing the query statement.

In an embodiment of the present disclosure, the apparatus 600 is configured to generate billing information corresponding to the query statement based on the amount of resources used by the target service model.

In an embodiment of the present disclosure, a process of training the target large model includes: obtaining model usage history data of a user associated with the query statement; determining a training sample set and a sample service model of a large model according to the model usage history data, in which, the training sample set includes sample query statements of the large model; determining reference labels of the sample query statements based on the sample service model; and training the large model based on the sample query statements, a model identifier of the sample service model, and reference labels of the sample query statements, and obtaining the target large model.

In an embodiment of the present disclosure, a process of determining the training sample set includes: obtaining candidate query statements according to the model usage history data, and obtaining target categories of the candidate query statements; grouping the candidate query statements according to the target categories to obtain a query statement set corresponding to each of the target categories; selecting part of candidate query statements from the query statement set corresponding to each category as sample query statements; obtaining the training sample set based on the sample query statements selected from each category.

In an embodiment of the present disclosure, a process of determining the training sample set includes: matching the candidate query statements with category description information of subcategories of preset second prompt words, and obtaining target subcategories matched with the candidate query statements; mapping the target subcategories to a plurality of predetermined candidate categories, and taking candidate categories to which the target subcategories are mapped as the target categories of the candidate query statements.

In an embodiment of the present disclosure, a process of determining the sample service model includes: obtaining candidate sample service models according to the model usage history data; and determining usage frequencies of the candidate sample service models, and selecting a candidate sample service model with a usage frequency greater than a predetermined value as the sample service model.

In an embodiment of the present disclosure, determining the reference labels of the sample query statements based on the sample service model includes: obtaining answer information of the sample query statements based on the sample service model; obtaining standard answer information for the sample query statements; determining the reference labels of the sample query statements based on the answer information and the standard answer information.

In an embodiment of the present disclosure, training the large model based on the sample query statements, the model identifier of the sample service model, and the reference labels of the sample query statements, and obtaining the target large model includes: generating a third prompt word based on the sample query statements and the model identifier of the sample service model; inputting the third prompt word into the large model, and obtaining, by the large model, predicted labels of the sample query statements based on the third prompt word; determining a loss function of the large model based on the predicted labels and the reference labels, and adjusting model parameters of the large model based on the loss function until training is completed to obtain the target large model.

In an embodiment of the present disclosure, before determining the at least one model identifier of the at least one candidate service model based on the query statement, the apparatus 600 is configured to receive the query statement sent by a client through a software development kit (SDK) component; parse the query statement, obtaining key information from the query statement, and generate a standard query statement based on the key information, in which, the key information at least includes the at least one model identifier of the at least one candidate service model and context information of the candidate service model.

In an embodiment of the present disclosure, before determining the at least one model identifier of the at least one candidate service model based on the query statement, the method further includes: the apparatus 600 is configured to convert a communication protocol of the standard query statement and authenticate and verify user identity information corresponding to the standard query statement.

According to the information processing apparatus provided in the present disclosure, the query statement of the user is obtained, and the at least one model identifier of the at least one candidate service model is determined based on the query statement. The at least one first prompt word is generated based on the query statement and the at least one model identifier, the at least one first prompt word is input into the pre-trained target large model, and the target large model outputs the at least one screening parameter of the at least one candidate service model based on the at least one first prompt word. The target service model is determined from the at least one candidate service model based on the at least one screening parameter. The query statement is inputted into the target service model, and the feedback information corresponding to the query statement is obtained. Therefore, in the present disclosure, with determining the target service model based on the at least one screening parameter of the at least one candidate service model output by the target large model, an efficiency, an accuracy, and flexibility of determining the target service model may be improved, and with inputting the query statement into the target service model to obtain the feedback information corresponding to the query statement, a computing capability of the target service model may be utilized to the most extent, and an efficiency and an accuracy of outputting the feedback information of the target service model may be ensured.

According to the embodiments of the present disclosure, an electronic device, a storage medium, and a computer program product are also provided.

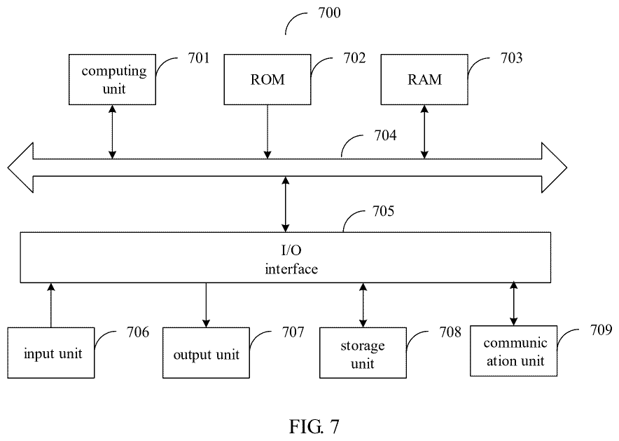

FIG. 7 is a block diagram of an electronic device 700 to implement the embodiments of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 7, the device 700 includes a computing unit 701, configured to execute various appropriate actions and processes according to a computer program stored in a read-only memory (ROM) 702 or a computer program loaded from a storage unit 708 to a random access memory (RAM) 703. In the RAM 703, various programs and data required for the device 700 may be stored. The computing unit 701, the ROM 702 and the RAM 703 may be connected with each other by a bus 704. An input/output (I/O) interface 705 is also connected to the bus 704.

The plurality of components in the device 700 are connected to the I/O interface 705, which include: an input unit 706, for example, a keyboard, a mouse; an output unit 707, for example, various types of displays, speakers; a storage unit 708, for example, a magnetic disk, an optical disk; and a communication unit 709, for example, a network card, a modem, a wireless transceiver. The communication unit 709 allows the device 700 to exchange information/data through a computer network such as Internet and/or various types of telecommunication networks with other devices.

The computing unit 701 may be various types of general and/or dedicated processing components with processing and computing abilities. Some examples of a computing unit 701 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 701 executes various methods and processes as described above, for example, a method for determining a training data set of a large reward model. For example, in some embodiments, the method for determining a training data set of a large reward model may be further implemented as a computer software program, which is tangibly contained in a machine readable medium, such as the storage unit 708. In some embodiments, a part or all of the computer program may be loaded and/or installed on the device 700 via the ROM 702 and/or the communication unit 709. When the computer program is loaded on the RAM 703 and executed by the computing unit 701, one or more steps in the method for determining a training data set of a large reward model may be performed as described above. Optionally, in other embodiments, the computing unit 701 may be configured to perform the information processing method in other appropriate ways (for example, by virtue of a firmware).

Various implementations of the systems and techniques described above may be implemented by one and/or a combination of a digital electronic circuit system, an integrated circuit system, a Field Programmable Gate Array (FPGA), an Application Specific Integrated Circuit (ASIC), an Application Specific Standard Product (ASSP), a System on Chip (SOC), a Load Programmable Logic Device (CPLD), a computer hardware, a firmware, and a software. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMS, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (e.g., a data server), or a computing system that includes middleware components (e.g., an application server), or a computing system that includes front-end components (e.g., a user computer with a graphical user interface or a web browser, through which the user may interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

According to the embodiments of the present disclosure, a computer program product including a computer program is also provided. When the computer program is executed by a processor, the information processing method in the embodiments of the present disclosure is implemented.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

1. An information processing method, comprising:
obtaining a query statement of a user, determining at least one model identifier of at least one candidate service model based on the query statement;
generating at least one first prompt word based on the query statement and the at least one model identifier, inputting the at least one first prompt word into a pre-trained target large model, and outputting, by the target large model, at least one screening parameter of the at least one candidate service model based on the at least one first prompt word;
determining a target service model from the at least one candidate service model based on the at least one screening parameter; and
inputting the query statement into the target service model, and obtaining feedback information corresponding to the query statement.

2. The method according to claim 1, wherein determining the target service model from the at least one candidate service model based on the at least one screening parameter comprises:
sorting the at least one candidate service model in descending order according to the at least one screening parameter, and selecting a first candidate service model ranked first as the target service model.

3. The method according to claim 1, wherein determining the target service model from the at least one candidate service model based on the at least one screening parameter comprises:
obtaining at least one current task amount of the at least one candidate service model, and determining the target service model from the at least one candidate service model based on the at least one current task amount and the at least one screening parameter.

4. The method according to claim 3, wherein determining the target service model from the at least one candidate service model based on the at least one current task amount and the at least one screening parameter comprises:
sorting the at least one candidate service model in descending order according to the at least one screening parameter, and selecting a first candidate service model ranked first; and
determining a second candidate service model ranked second as the target service model in response to the current task amount of the first candidate service model being greater than a predetermined threshold.

5. The method according to claim 3, wherein determining the target service model from the at least one candidate service model based on the at least one current task amount and the at least one screening parameter comprises:
sorting the at least one candidate service model in descending order according to the at least one screening parameter to obtain a first sorting result;
obtaining at least one current task amount of the at least one candidate service model, and adjusting the first sorting result based on the at least one current task amount to obtain a second sorting result; and
selecting a third candidate service model sorted first in the second sorting result as the target service model.

6. The method according to claim 1, wherein, after obtain the feedback information corresponding to the query statement, the method comprises:
monitoring the amount of resources used by the target service model during a process of processing the query statement.

7. The method according to claim 6, further comprising:
generating billing information corresponding to the query statement based on the amount of resources used by the target service model.

8. The method according to claim 1, wherein a process of training the target large model comprises:
obtaining model usage history data of a user associated with the query statement;
determining a training sample set and a sample service model of a large model according to the model usage history data, wherein the training sample set comprises sample query statements of the large model;
determining reference labels of the sample query statements based on the sample service model; and
training the large model based on the sample query statements, a model identifier of the sample service model, and reference labels of the sample query statements, and obtaining the target large model.

9. The method according to claim 8, wherein a process of determining the training sample set comprises:
obtaining candidate query statements according to the model usage history data, and obtaining target categories of the candidate query statements;
grouping the candidate query statements according to the target categories to obtain a query statement set corresponding to each of the target categories;
selecting part of candidate query statements from the query statement set corresponding to each category as sample query statements;
obtaining the training sample set based on the sample query statements selected from each category.

10. The method according to claim 9, wherein a process of determining the training sample set comprises:
matching the candidate query statements with category description information of subcategories of preset second prompt words, and obtaining target subcategories matched with the candidate query statements;
mapping the target subcategories to a plurality of predetermined candidate categories, and taking candidate categories to which the target subcategories are mapped as the target categories of the candidate query statements.

11. The method according to claim 8, wherein a process of determining the sample service model comprises:
obtaining candidate sample service models according to the model usage history data; and
determining usage frequencies of the candidate sample service models, and selecting a candidate sample service model with a usage frequency greater than a predetermined value as the sample service model.

12. The method according to claim 8, wherein determining the reference labels of the sample query statements based on the sample service model comprises:
obtaining answer information of the sample query statements based on the sample service model;
obtaining standard answer information for the sample query statements;
determining the reference labels of the sample query statements based on the answer information and the standard answer information.

13. The method according to claim 8, wherein training the large model based on the sample query statements, the model identifier of the sample service model, and the reference labels of the sample query statements, and obtaining the target large model comprises:
generating a third prompt word based on the sample query statements and the model identifier of the sample service model;
inputting the third prompt word into the large model, and obtaining, by the large model, predicted labels of the sample query statements based on the third prompt word;
determining a loss function of the large model based on the predicted labels and the reference labels, and adjusting model parameters of the large model based on the loss function until training is completed to obtain the target large model.

14. The method according to claim 1, wherein, before determining the at least one model identifier of the at least one candidate service model based on the query statement, the method further comprises:
receiving the query statement sent by a client through a software development kit (SDK) component;
parsing the query statement, obtaining key information from the query statement, and generating a standard query statement based on the key information, wherein the key information at least comprises the at least one model identifier of the at least one candidate service model and context information of the candidate service model.

15. The method according to claim 14, wherein, before determining the at least one model identifier of the at least one candidate service model based on the query statement, the method further comprises:
converting a communication protocol of the standard query statement and authenticating and verifying user identity information corresponding to the standard query statement.

16. An electronic device, comprising a processor and a memory, wherein
the processor is configured to obtain a query statement of a user, determining at least one model identifier of at least one candidate service model based on the query statement; generate at least one first prompt word based on the query statement and the at least one model identifier, input the at least one first prompt word into a pre-trained target large model, and output, by the target large model, at least one screening parameter of the at least one candidate service model based on the at least one first prompt word; determine a target service model from the at least one candidate service model based on the at least one screening parameter; and input the query statement into the target service model, and obtain feedback information corresponding to the query statement.

17. A computer-readable storage medium storing a computer program, which, when executed by a processor, causes an information processing method to be implemented, wherein the method comprises:
obtaining a query statement of a user, determining at least one model identifier of at least one candidate service model based on the query statement;
generating at least one first prompt word based on the query statement and the at least one model identifier, inputting the at least one first prompt word into a pre-trained target large model, and outputting, by the target large model, at least one screening parameter of the at least one candidate service model based on the at least one first prompt word;
determining a target service model from the at least one candidate service model based on the at least one screening parameter; and
inputting the query statement into the target service model, and obtaining feedback information corresponding to the query statement.
